(19) United States
(12) Patent Application Publication
(10) Pub. No.: US 2005/0174548 A1
(43) Pub. Date: Aug. 11, 2005

(54) Finishing apparatus for photographic laboratories

(76) Inventor: Marcello Acerboni, Zero Branco (IT)

Correspondence Address: Hoffman, Wasson & Gitler, P.C.;Crystal Center 2, Suite 522, 2461 South Clark Street, Arlington, VA, 22202-3823, US

(21) Appl. No.: 11/053,921

(22) Filed: Feb. 10, 2005

(30) Foreign Application Priority Data
Feb. 11, 2004 (IT) VE2004A000006

(51) Int. Cl. G03B 27/52

(52) U.S. Cl. 355/29

(57) ABSTRACT

A finishing apparatus for photographic laboratories having at least two elements for advancing separate strips of photographic paper, carrying images printed thereon, towards two corresponding cutters and two members for conveying the prints cut by the cutters from the paper strips. The two members being vertically superposed at least in that part most distant from the cutters. Also provided is a collector facing the exits of said conveyor members, and provided with elements for selective feeding towards at least one shelf. A code reader is present on the conveyor belt to indicate those prints pertaining to the same customer order. The apparatus has a control unit which receives signals from the readers and initially causes a first cutter to cut all those prints of the first paper strip which pertain to the same customer order, and causes them to advance along the corresponding conveyor member towards the collector, and then causes the second cutter to cut all those prints of the second strip which pertain to the same customer order as that corresponding to the customer order of the first strip, and causes them to advance along the corresponding conveyor member towards the collector.

### BACKGROUND OF THE INVENTION

The present invention relates to a finishing apparatus for photographic laboratories.

Finishing apparatus for photographic laboratories are known consisting of a member for advancing a paper strip carrying images printed thereon, a strip cutter to obtain the individual prints, a conveyor belt for the individual prints, and a selector which receives the prints.

In analogue developing and printing technology, the individual film rolls are printed on a paper strip of predefined height and finishing quality, whereas to obtain copies of different characteristics the negative has to be again dispatched to the laboratory, specifying that image which is to be reprinted, the type of paper and the format dimensions.

The development of digital printing has enabled this drawback to be obviated, so that the user can study an overview of the various photographs in the shop and define for each of them the number of copies, the type of format and the type of paper to be used.

In the photographic laboratory, on the basis of the choices made in the shop, an information reader prints the images on paper strips which are different in terms both of format and of finish. The different paper strips containing different customer orders are fed to corresponding finishing stations in which they are cut into individual prints, which are then grouped on the basis of the same customer order.

Packs of those prints of the various stations, which pertain to the same customer order, are then collected manually and inserted into an envelope, which is dispatched to the shop for delivery to the user.

This system presents however the drawback of a considerable labor requirement due to the manual step of collecting the photographs from the various stations and inserting them into the envelope.

### SUMMARY OF THE INVENTION

A finishing apparatus for photographic laboratories having at least two elements for advancing separate strips of photographic paper, carrying images printed thereon, towards two corresponding cutters and two members for conveying the prints cut by the cutters from the paper strips. The two members being vertically superposed at least in that part most distant from the cutters. Also provided is a collector facing the exits of said conveyor members, and provided with elements for selective feeding towards at least one shelf. A code reader is present on the conveyor belt to indicate those prints pertaining to the same customer order. The apparatus has a control unit which receives signals from the readers and initially causes a first cutter to cut all those prints of the first paper strip which pertain to the same customer order, and causes them to advance along the corresponding conveyor member towards the collector, and then causes the second cutter to cut all those prints of the second strip which pertain to the same customer order as that corresponding to the customer order of the first strip, and causes them to advance along the corresponding conveyor member towards the collector.

### BRIEF DESCRIPTION OF THE FIGURE

A preferred embodiment of the present invention is described in detail hereinafter with reference to the accompanying drawing:

FIG. 1 shows a longitudinal schematic section through a finishing device according to the invention.

### DETAILED DESCRIPTION OF THE INVENTION

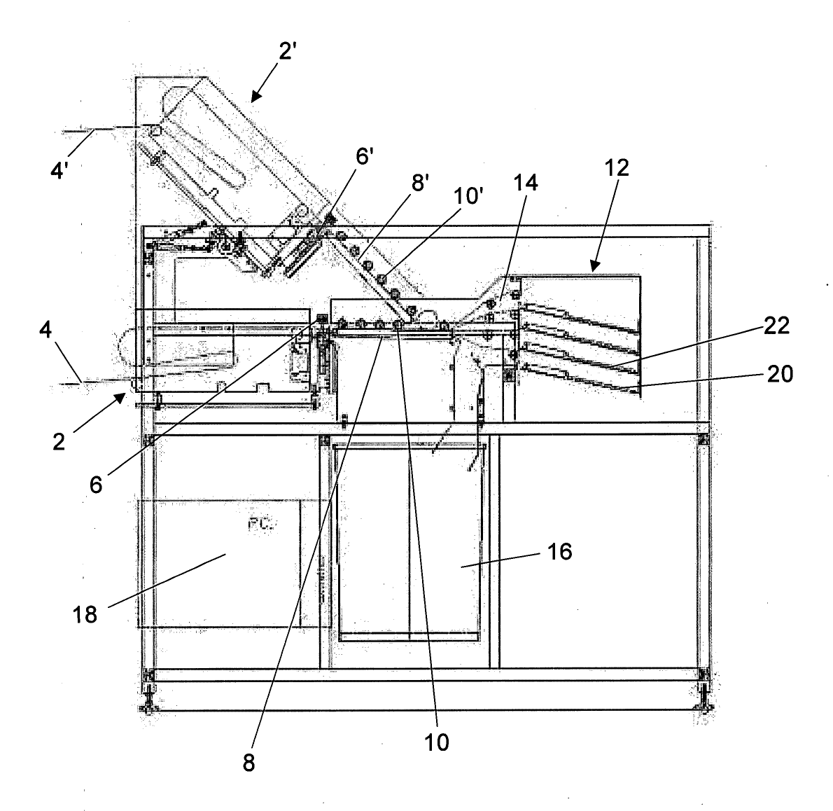

As can be seen from FIG. 1, the finishing apparatus according to the invention has two members 2, 2′ for transferring two photographic paper strips 4, 4′ of different characteristics (height, finish or both).

At the exit of the two transfer members, there are provided two cutters 6, 6′ faced by two superposed conveyor members 8, 8′ formed from endless belts extending between two rollers, both motorized.

On the upper portion of the belts, there are provided a plurality of presser rollers 10, 10′ mounted idle on respective shafts and maintained with their lateral surface elastically in contact with the belts.

The lower end of the upper conveyor member 8′ substantially faces the central portion of the lower conveyor member 8.

At the exit end of the lower conveyor member 8, i.e. at that end distant from the cutter 6, there is provided a selector device 12, of known type, essentially consisting of superposed articulated blades 14 which, depending on their angular position, present the conveyor with a different exit for conveying the individual prints towards a different path with which a shelf corresponds.

In the illustrated example the blades enable five different exits to be obtained, corresponding to five different paths for the prints. The lower path constitutes the discard path and deviates the prints towards a collection container 16. The other paths are for prints of different formats or different paper type or both.

The device of the invention also has a plurality of sensors, automatic controls and servomechanisms which together effect the correct operative cycle and will be described in the ensuing description of operation as they arise.

In describing the operation of the device, it will firstly be assumed that the two transfer devices for the paper strip have been loaded with two different types of paper of different height, different finish or both, and that they carry the printed images in the same arrangement as the customer orders from which they originate.

At this point, by means of optical readers (not present in the drawings) for codes present on the paper strip, a control unit 18 causes the strip cutter 6 to cut off in succession all the prints pertaining to the same customer order, these prints advancing along the conveyor member 8 to be fed to the lower shelf 20 of the selector 12, with the exception of those to be discarded.

When the reader senses the end of the prints pertaining to this order, the unit 19 causes the upper strip 4′ to advance with consequent cutting of all the prints pertaining to the same customer order as those previously cut from the strip 4, these being advanced along the conveyor member 8′ to fall onto the horizontal conveyor member 8 and be fed onto the shelf 22 of the selector 12 by manipulating the blades 14.

At this point a traditional device collects the prints collected in the selector to feed them to the envelope for delivery to the customer. At the same time the lower strip 4 again advances to enable the cutter to separate the prints pertaining to the next customer order and recommence the working cycle.

1. A finishing apparatus for photographic laboratories, comprising:
at least two elements for advancing separate strips of photographic paper, carrying images printed thereon, towards two corresponding first and second cutters;
two members for conveying prints cut by the first and second cutters from the separate strips of photographic paper, said two members being vertically superposed at least in a part most distant from the first and second cutters;
a collector facing exits of the two conveyor members, and provided with elements for selective feeding towards at least one shelf;
code readers present on a conveyor belt, to indicate those prints pertaining to the same customer order;
a control unit which receives signals from the code readers and initially causes the first cutter to cut all those prints of a first paper strip which pertain to the same customer order, causes them to advance along a corresponding conveyor member towards the collector, and then causes a second cutter to cut all those prints of a second strip which pertain to the same customer order as that corresponding to the customer order of the first strip, and causes them to advance along the corresponding conveyor member towards the collector.

2. The apparatus as claimed in claim 1, wherein the two conveyor members are formed from endless belts extending between motorized rollers.

3. The apparatus as claimed in claim 1, wherein the collector comprises superposed articulated blades for feeding towards superposed shelves.
